(19) United States
(12) Patent Application Publication
(10) Pub. No.: US 2016/0122677 A1
(43) Pub. Date: May 5, 2016

(54) Liquid-Infused Surfaces Featuring Reduced Drag Characteristics, and Methods for Fabricating the Same

(71) Applicant: The Trustees of Princeton University, Princeton, NJ (US)

(72) Inventors: Matthew Fu, Princeton, NJ (US); Marcus Hultmark, Princeton, NJ (US); Ian Jacobi, Highland Park, NJ (US); Brian Rosenberg, Princeton, NJ (US); Alexander Smits, Princeton, NJ (US); Howard Stone, Princeton, NJ (US); Jason Wexler, Princeton, NJ (US)

(21) Appl. No.: 14/927,946

(22) Filed: Oct. 30, 2015

Related U.S. Application Data
(60) Provisional application No. 62/072,499, filed on Oct. 30, 2014.
(60) Provisional application No. 62/152,541, filed on Apr. 24, 2015.

(51) Int. Cl. C10M 105/76; G01B 5/02; G01N 11/00; C10M 105/14

(52) U.S. Cl. CPC C10M 105/76; C10M 105/14; G01B 5/02; G01N 11/00

(57) ABSTRACT

In a broad aspect of the invention there are provided liquid infused surfaces that feature drag reducing characteristics.

In a further broad aspect, the present invention provides methods for designing and fabricating liquid infused surfaces that feature drag reducing characteristics.

In a yet further broad aspect the present invention provides methods for increasing the operating efficiency of systems in which a flowing bulk fluid is in contact with a patterned surface, the increased operating efficiency specifically being realized from a reduction of the drag forces due to the bulk fluid flowing over the patterned surface.

This application incorporates by reference the entirety of the disclosures of U.S. Provisional Patent Application Ser. No. 62/072,499 filed 30 Oct. 2014 and U.S. Provisional patent application Ser. No. 62/152,541 filed 24 Apr. 2015 as if fully set forth herein.

This invention was made with government support under Grants No. N00014-12-1-0875 and No. N00014-12-1-0962 awarded by the Office of Naval Research. The government has certain rights in the invention.

The reduction of surface drag of a fluid traversing a surface is of great interest in a plethora of technical fields, i.e., chemical engineering, civil engineering, mechanical engineering, biomedical engineering, as well as in the medical and biological sciences. As is known, surface drag factors reduce the efficiency of the transport of a bulk fluid, which may be a liquid or gas. Surface drag also reduces the efficiency of bodies passing through a bulk fluid, either a liquid or gas.

One solution suggested by the prior art is through the use of super-hydrophobic surfaces. Super-hydrophobic surfaces repel water, and reduce drag by maintaining a thin gas layer within their surface topography. The thin layer of gas thus acts as a barrier or cushion between a surface and a bulk fluid. Unhelpfully, the thin gas layer is difficult to maintain, and if it is a compressible and/or soluble in the bulk fluid is susceptible to degradation, and to pressure-induced instabilities.

A further solution suggested by the art is through the use of liquid infused surfaces, which retain a thin layer of a liquid within a surface across which is in contact with a bulk fluid. Such provides certain benefits over gas layers, including that the thin lay er of liquid is essentially incompressible, thus avoiding pressure-induced instabilities and further, selection of the liquid within the thin layer relative to that of the bulk fluid can be done to reduce solubility and loss of the thin layer liquid into the bulk fluid. However, the use of such thin liquid layers is not without shortcomings. The orientation of the surface, particularly a vertical orientation may induce unwanted drainage of the thin layer due to the effects of gravity. Further, such thin layers may suffer failure due to viscous effects, i.e., they may be drained due to the shear stress imparted by the bulk fluid upon the thin liquid layer.

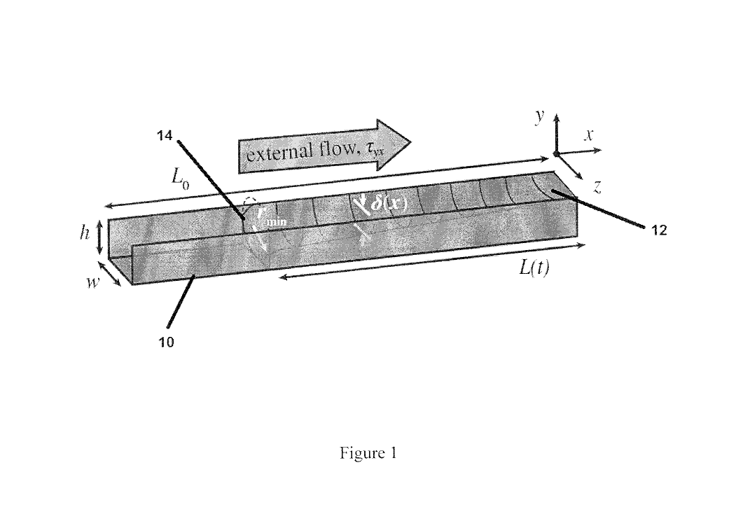

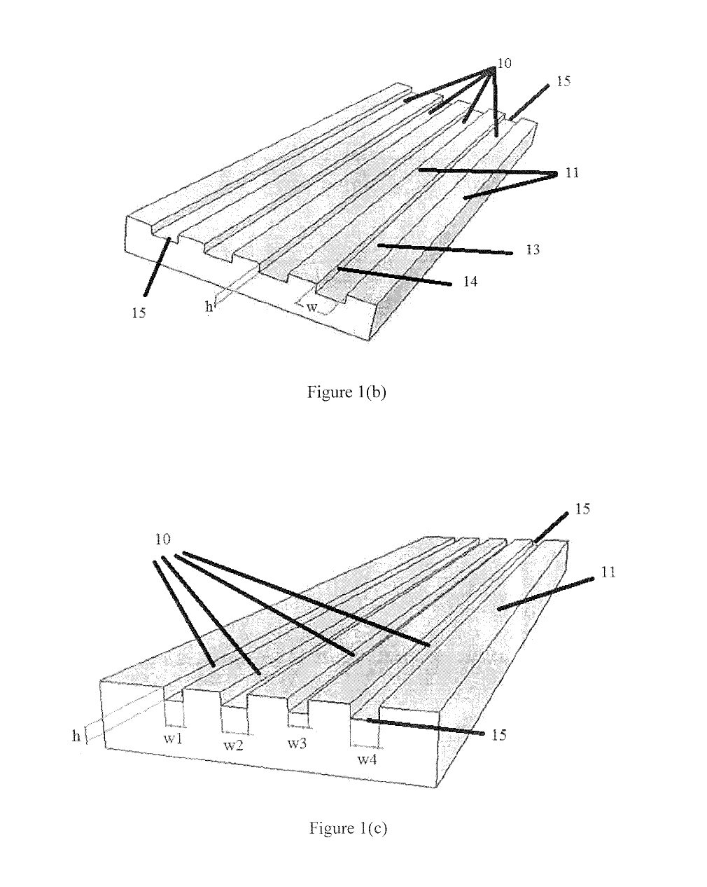

FIG. 1 depicts a schematic representation of a channel.

FIGS. 1(b)-1(f) illustrate preferred embodiments of patterned surfaces of bodies according to the invention.

FIG. 1(b) depicts a surface comprising a plurality of generally rectangular grooved channels.

FIG. 1(c) illustrates an alternative configuration of a surface comprising a plurality of generally rectangular grooved channels.

FIG. 1(d) depicts a surface comprising a plurality of generally rectangular grooved channels, having channels of different heights.

FIG. 1(e) depicts a surface comprising a plurality of generally rectangular grooved channels as well as barriers between grooved channels.

FIG. 1(f) depicts a surface comprising a plurality of generally rectangular and parallel grooved channels having uniformly spaced transverse barriers.

FIG. 1(g) depicts a surface comprising a plurality of generally rectangular and parallel grooved channels having offset transverse barriers.

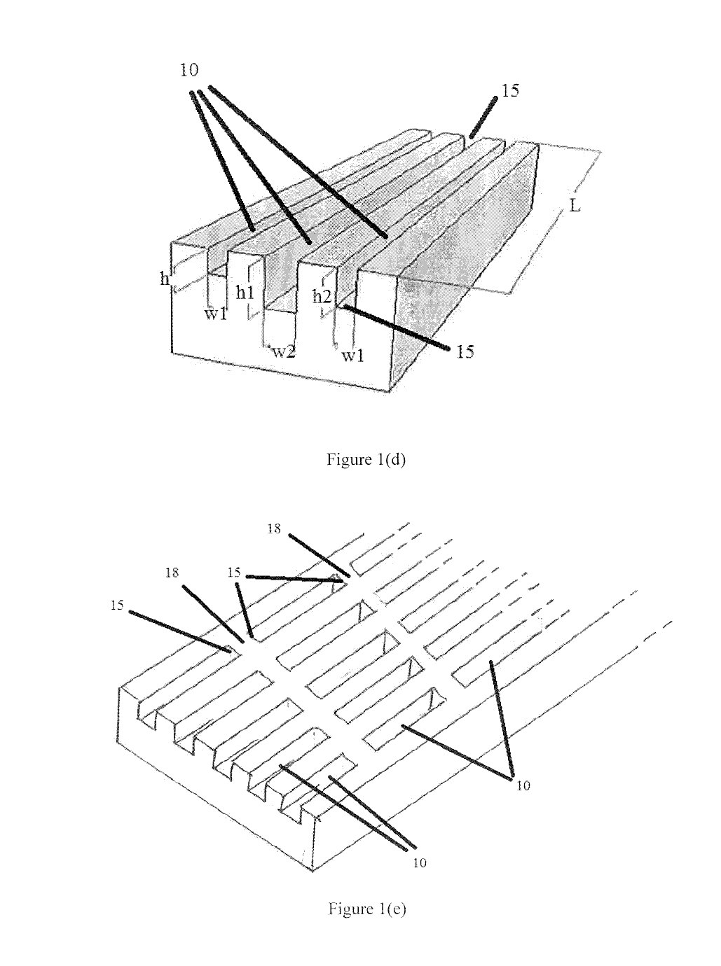

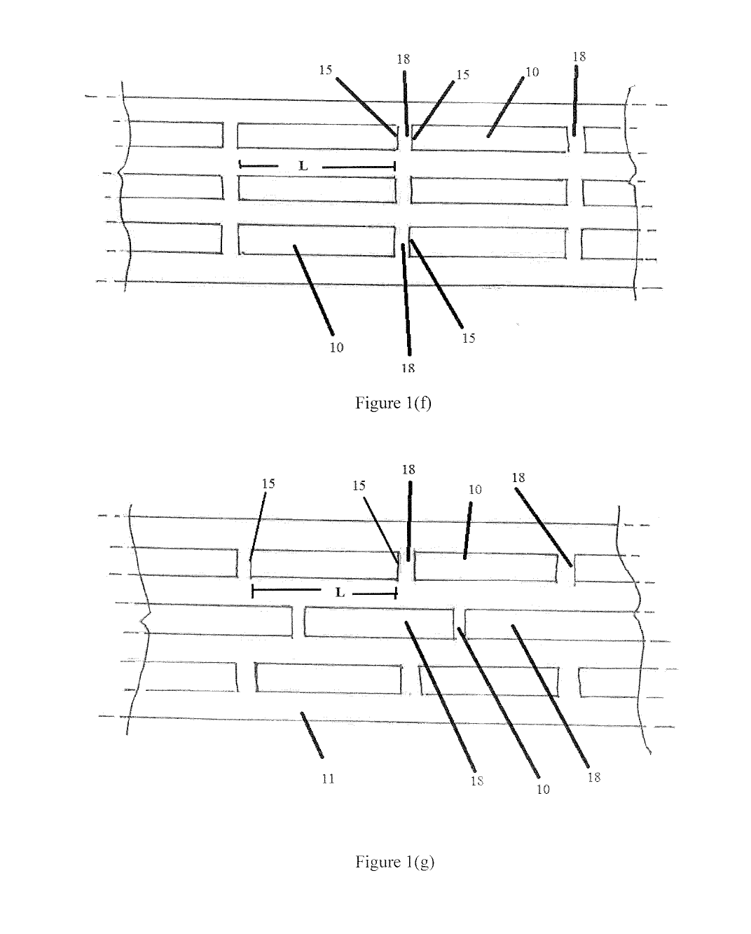

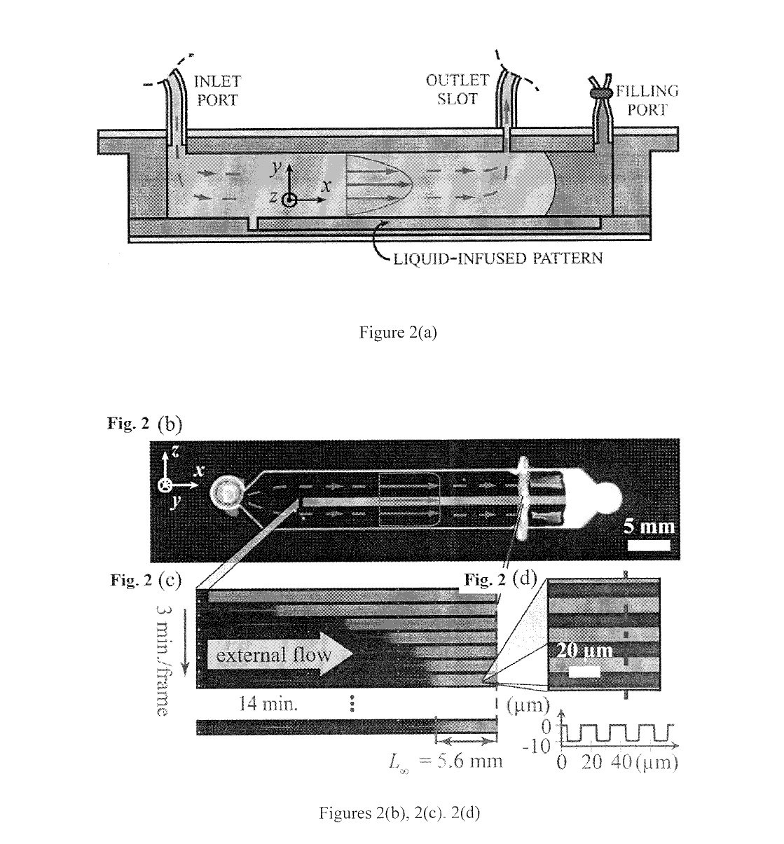

FIG. 2(a) illustrates a microfluidic flow cell with a patterned surface having streamwise grooves.

FIG. 2(b) illustrates a representation of the microfluidic flow cell of FIG. 2(a).

FIG. 2(c) shows a detail of a section of the microfluidic flow cell of FIG. 2(a).

FIG. 2(d) depicts a detail of a further section of the microfluidic flow cell of FIG. 2(a).

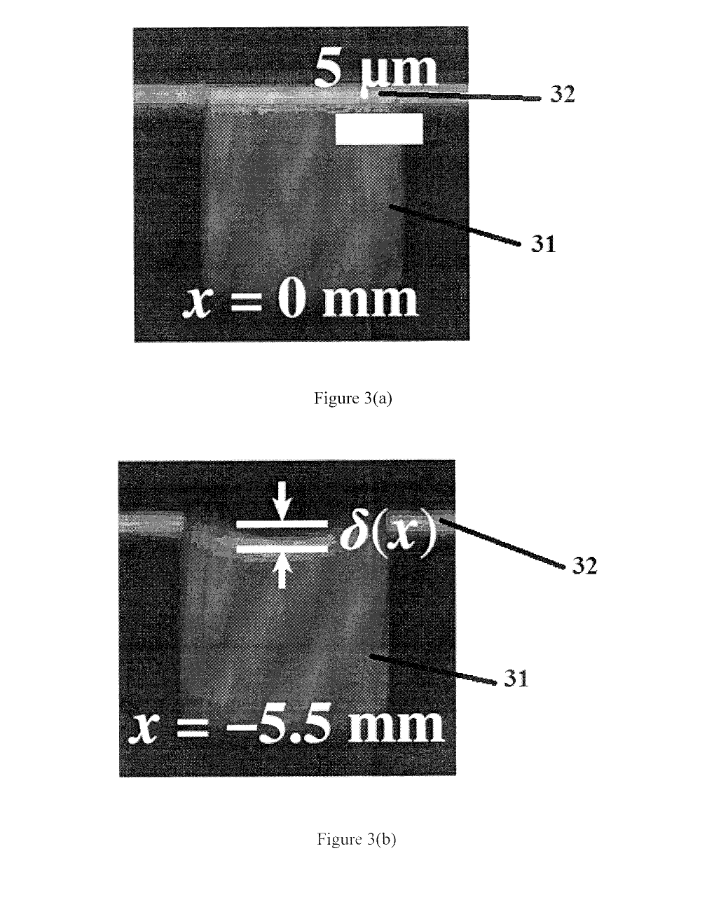

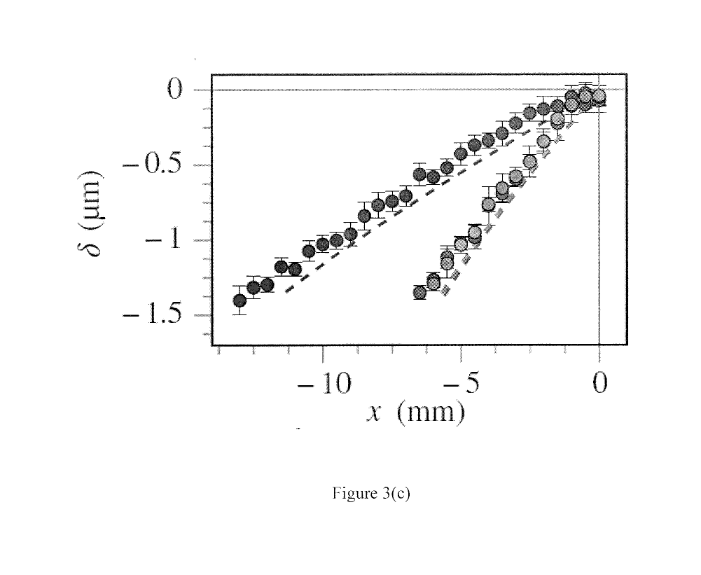

FIG. 3(a) illustrates a cross-sectional image of a steady-state oil distribution were taken in the streamwise (x) direction at a part of a filled portion of a groove.

FIG. 3(b) illustrates a further cross-sectional image of a steady-state oil distribution were taken in the streamwise (x) direction at a part of a filled portion of a groove. FIG. 3(c) is a graph illustrating interfacial deflection at the groove center δ versus x.

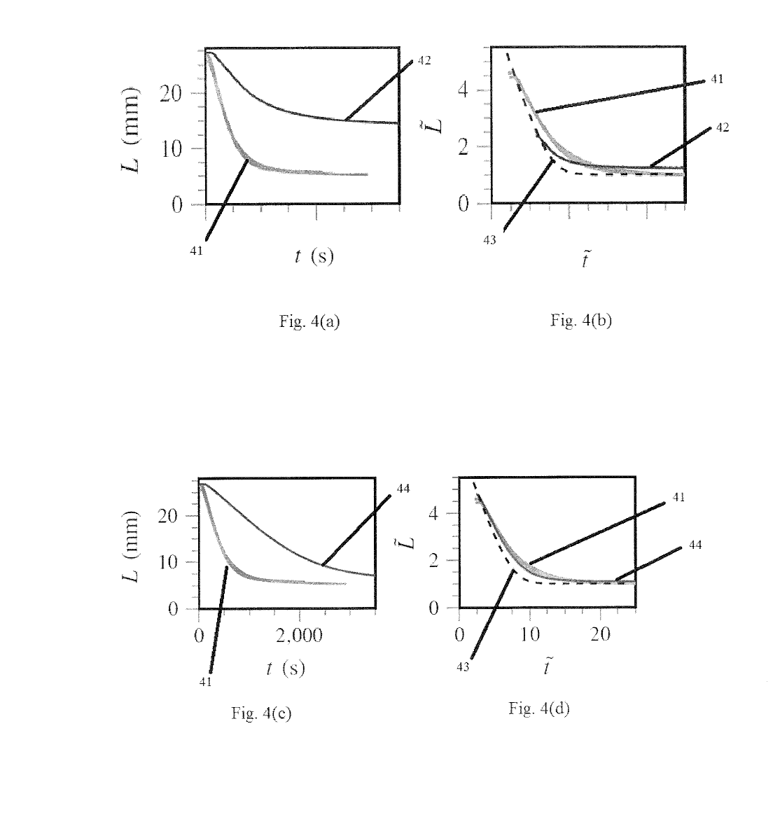

FIGS. 4(a) and 4(b) depict drainage curves for grooves of a single fluid, at different flowrates, plotted as length versus time.

FIGS. 4(c) and 4(d) depict drainage curves for grooves of two fluids of different viscosity but both at a flow rate of Q=2 mL/minute through a cell.

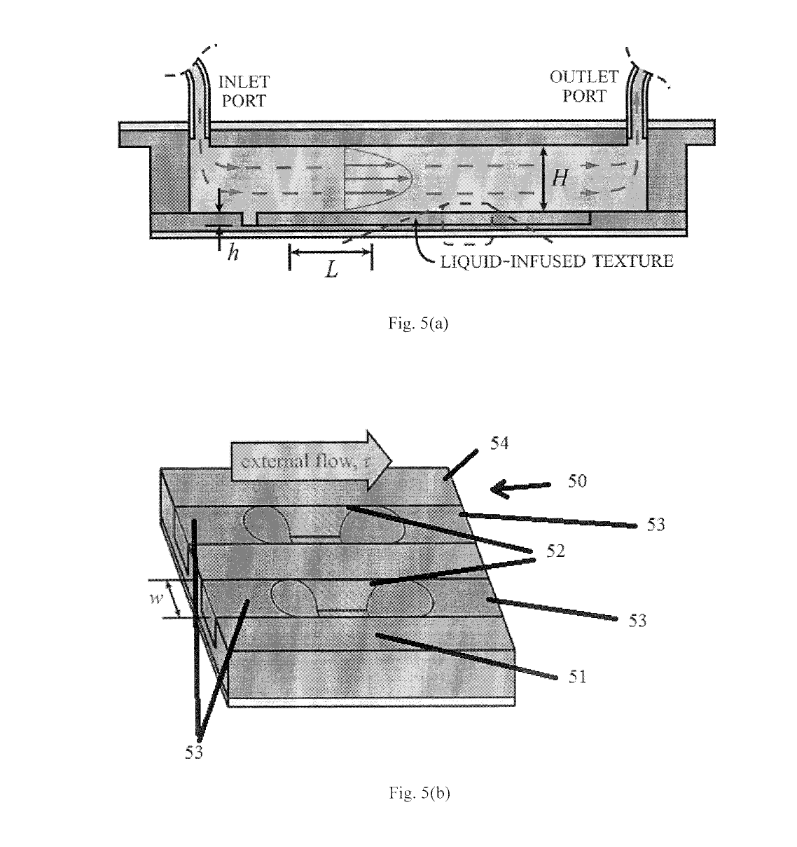

FIG. 5(a) depicts a cross-sectional view of a fluidic device.

FIG. 5(b) illustrates a detail of a patterned surface of a flow cell.

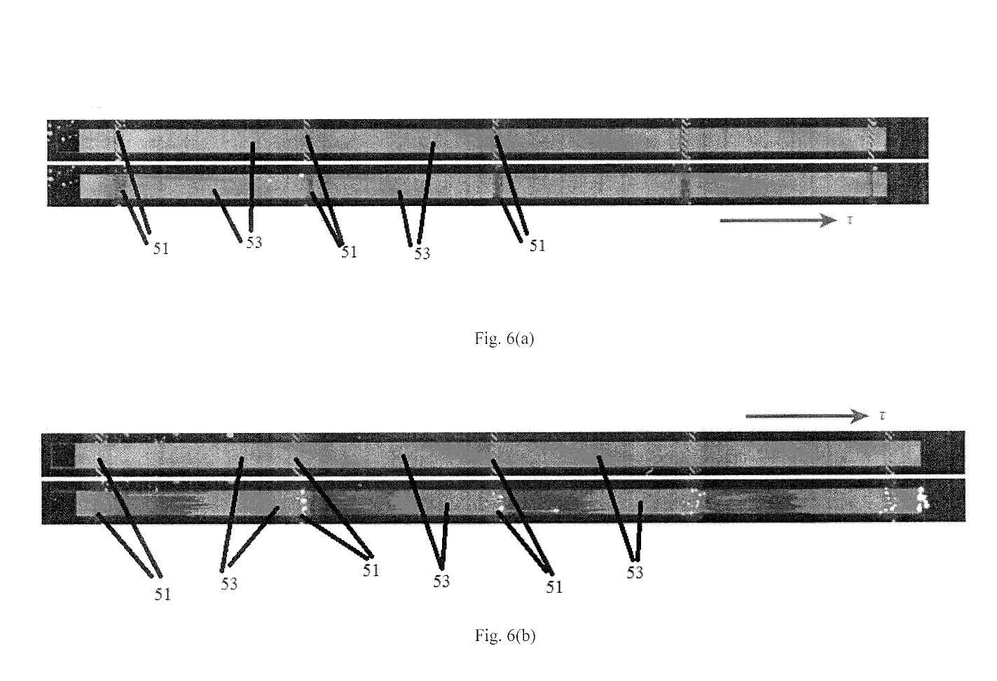

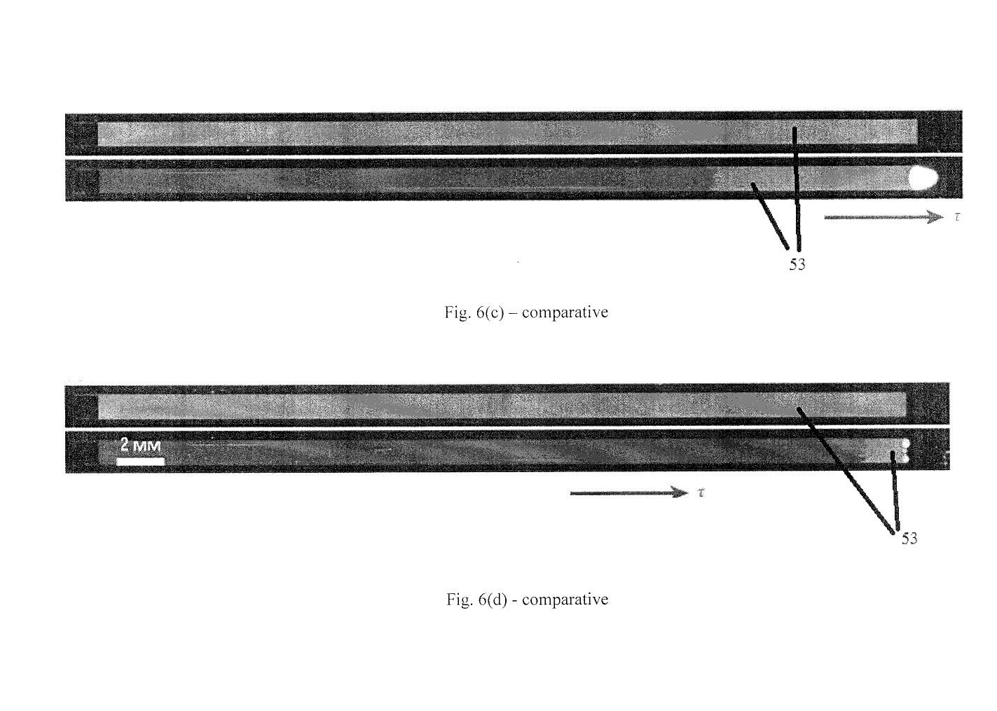

FIG. 6(a) depicts an image of a patterned surface of a flow cell, the flow cell having a series of exposed hydrophilic images traversing grooves in the surface of the flow cell.

FIG. 6(b) illustrates a further image of a patterned surface of a flow cell, the flow cell having a series of exposed hydrophilic images traversing grooves in the surface of the flow cell.

FIG. 6(c) depicts an image of a comparative flow cell having a patterned surface, which patterned surface did not include exposed hydrophilic images traversing grooves in the surface of the flow cell.

FIG. 6(d) illustrates a further image of a comparative flow cell having a patterned surface, which patterned surface did not include exposed hydrophilic images traversing grooves in the surface of the flow cell.

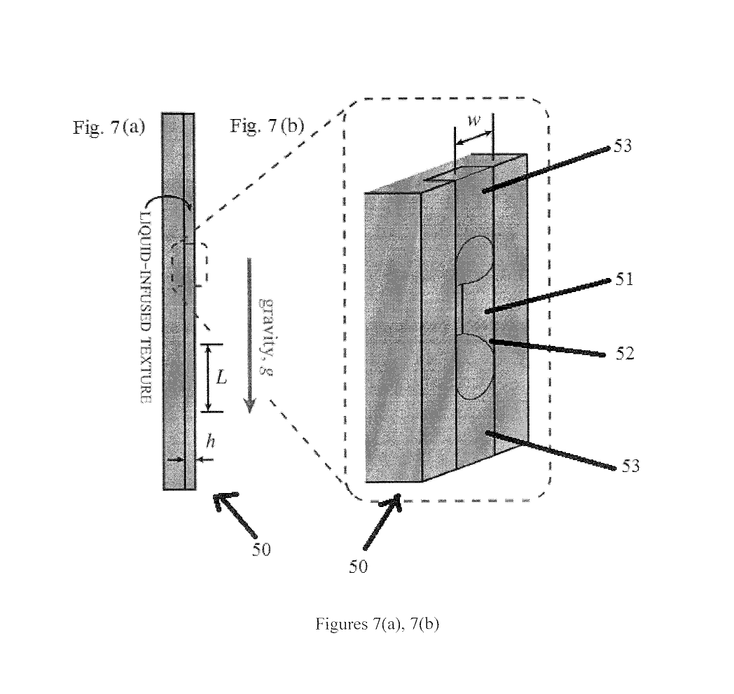

FIG. 7(a) illustrates a flow cell having a patterned surface in a vertical orientation.

FIG. 7(b) illustrates a detail of the flow cell of FIG. 7(a).

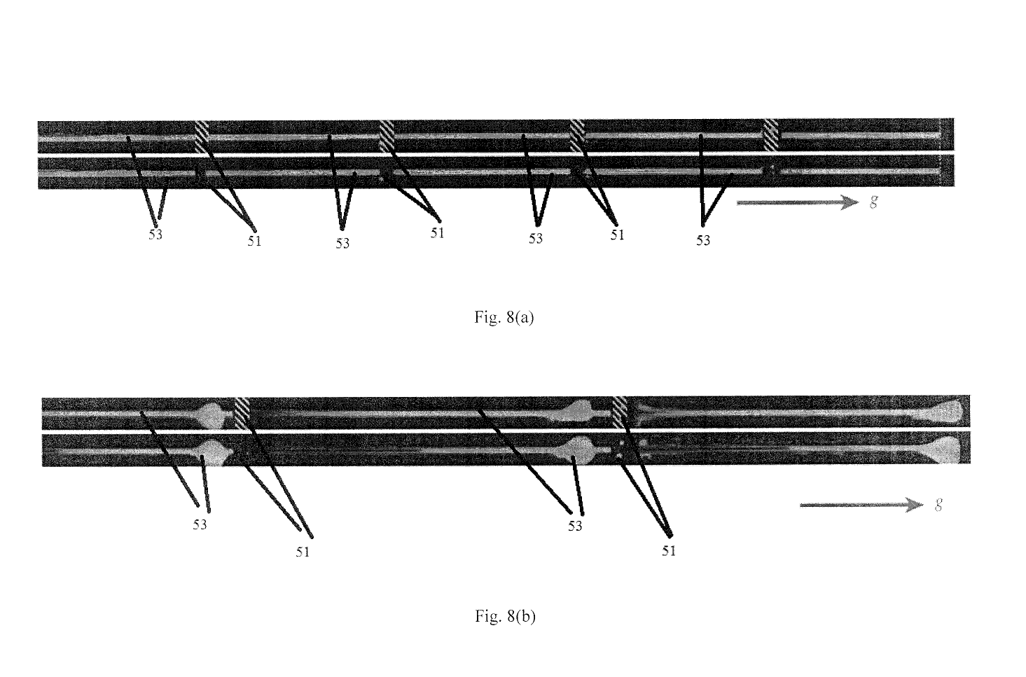

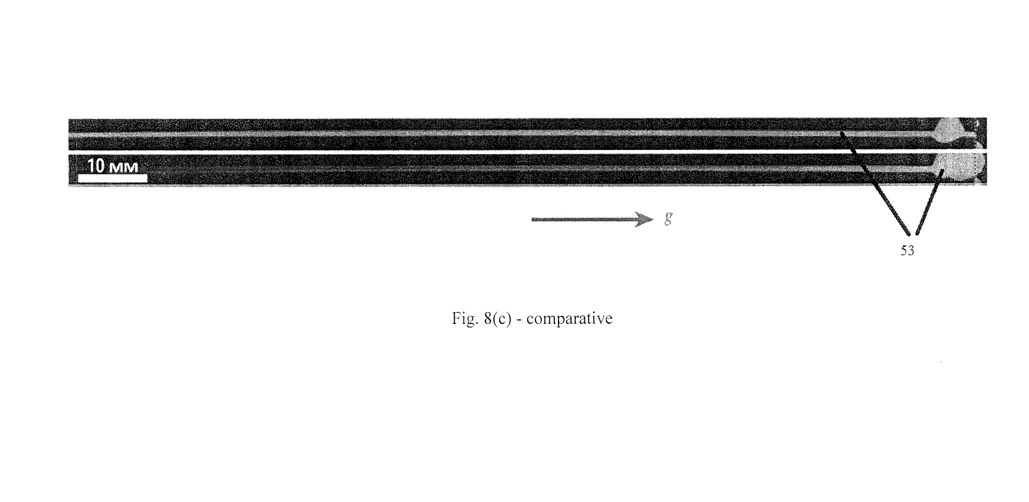

FIG. 8(a) illustrates as a liquid infused surface, a milled acrylic plate having patterned regions of different wettability.

FIG. 8(b) illustrates a further milled acrylic plate having patterned regions of different wettability.

FIG. 8(c) depicts a comparative milled acrylic plate without patterned regions of different wettability.

In a broad aspect of the invention there are provided liquid infused surfaces that feature drag reducing characteristics.

In a further broad aspect, the present invention provides methods for designing and fabricating liquid infused surfaces that feature drag reducing characteristics.

In a yet further broad aspect the present invention provides methods for increasing the operating efficiency of systems in which a flowing bulk fluid is in contact with a patterned surface, the increased operating efficiency specifically being realized from a reduction of the drag forces due to the bulk fluid flowing over the patterned surface.

In another aspect is provided a liquid infused surface comprising a pattered surface and a lubricating liquid contained within said patterned surface, wherein when the lubricating liquid is in interfacial contact with a flowing bulk liquid, flow is induced within the lubricating liquid and the lubricating liquid is retained within the patterned surface.

In another aspect the present invention provides liquid infused surfaces with drag reducing characteristics, wherein the said liquid infused surfaces are patterned surfaces which include one or more cavities, preferably channel type cavities extending inwardly from the surface therefrom, which cavities contain a lubricating liquid, wherein the dimensions of the one or more cavities of such that the lubricating liquid is retained when in contact with a flowing bulk fluid which imparts a shear force against the lubricating liquid.

In another aspect the present invention provides liquid infused surfaces with drag reducing characteristics, wherein the said liquid infused surfaces are patterned surfaces having upwardly extending protrusions which extend outwardly from the surface therefrom wherein the surface contains a lubricating liquid between extending protrusions, wherein the dimensions of the one or more protrusions with respect to the area of the surface are such that the lubricating liquid is retained upon the surface when in contact with a flowing bulk fluid which imparts a shear force against the lubricating liquid.

In another aspect are provided liquid infused surface with reduced drag characteristics, wherein the said liquid infused surface is a patterned surfaces having a roughened surface wherein the surface contains a lubricating liquid within the roughened surface, wherein the dimensions of the roughened surface as such that the lubricating liquid is retained upon the surface when in contact with a flowing bulk fluid which imparts a shear force against the lubricating liquid.

In a still further aspect the present invention provides liquid infused surfaces with drag reducing characteristics, wherein the said liquid infused surfaces include one or more channel type cavities extending inwardly into the body from the surface therefrom, which cavities contain a lubricating liquid, wherein the channel type cavities define a volume below a surface and within a body defined by one or more sidewalls, optionally but preferably a base inwardly from the surface and between the one or more sidewalls, and an open side (or open face) of the cavity which is coincident with the surface of the body, which cavities are adapted to contain a quantity of the lubricating liquid and to retain lubricating liquid within when the said surface of the body is in contact with a flowing bulk fluid which imparts a shear force against the said surface of the body.

In a yet further aspect the present invention provides liquid infused surfaces with reduced drag characteristics, wherein the said liquid infused surfaces include at least two channel type cavities oriented in a flow-wise direction separated by an intermediate barrier, each cavity extending inwardly into the body from the surface therefrom, which cavities contain a lubricating liquid, wherein the channel type cavities define a volume below a surface and within a body defined by one or more sidewalls, optionally but preferably a base, and an open side (or open face) of the cavity which is coincident with the surface of the body, each of which cavities are adapted to contain a quantity of the lubricating liquid and to retain lubricating liquid within when the said surface of the body is in contact with a flowing bulk fluid which imparts a shear force against the said surface of the body, and wherein the intermediate barrier is shorter than the greatest dimension of an adjacent channel type cavity.

In a yet further aspect of the invention the present invention provides A method of fabricating liquid infused surfaces which feature reduced drag characteristics for a lubricating liquid and a bulk fluid, which method comprises the steps of:

determining suitable dimensions for surface features for the liquid infused surface by,

establishing for a lubricating liquid to be retained within the one or more cavities present below the surface, and for a bulk fluid to be in flowing contact with the surface and with the exposed lubricating liquid, one or both of:
(a) a drag force present at the interface of the exposed surface of lubricating liquid and the flowing bulk fluid; and/or
(b) the maximum satisfactory length, L_{∝}, of the surface features, under steady-state flow conditions of the bulk fluid flowing across the surface.

In a yet further aspect there provided systems which include bodies with liquid infused surfaces which exhibit reduced drag when contacted with a flowing bulk fluid, which may be a liquid or a gas, as is herein described.

These and further aspects of the invention will be better understood from a reading of the following specification.

The invention described herein finds use with a lubricating liquid which infuses the patterned surface of the body, and a bulk fluid, which may be a liquid or gas, which bulk fluid transits across the pattern surface. The lubricating liquid be a single liquid, or single gas, or may be comprised of a plurality of liquids or a plurality of gases, respectfully a liquid mixture, or a gas mixture. The lubricating liquid is desirably substantially incompressible. The bulk fluid (which hereinafter, may sometimes also be referred to as a “bulk liquid” as appropriate) may be compressible if it is a gas or is a liquid containing a dissolved gas as might be the case when a liquid containing a gas is used as the bulk fluid, but advantageously the bulk fluid is an incompressible liquid, viz. “bulk liquid”. It is only required that under steady state flow conditions, that the bulk fluid come into interfacial contact with the lubricating fluid infused within or upon the patterned surface, and exert a shear force on the exposed surface of the lubricating fluid presented to the bulk fluid by the patterned surface. In the case of patterned surface comprising a plurality of cavities, then the exposed surface is defined by the cavities, and in particular the open faces thereof. In the case that the patterned surface comprises upwardly extending protrusions extending outwardly from the surface therefrom, the bulk fluid may come into interfacial contact with the lubricating fluid infused between extending protrusions of the patterned surface.

The body may be essentially a three-dimensional article and comprises a surface which surface includes a pattern having features adapted to retain the lubricating liquid therein/thereon under steady state flow conditions of the bulk fluid. By way of non-limiting example, the body may form part of an apparatus, or be part of a vehicle. Non-limiting examples such body may be a conduit, including, tubes, noncircular flow conduits, open channels, weirs, ducts, fluid-containing vessels, or any other plenum which may be used to contain a flowing liquid. The body may also form part of an apparatus, such as a portion of the valve, pump impeller, flow directing or any other surface which may be encountered in a liquid, or fluid pathways or fluid circuits. Further non-limiting examples of a body include cylinders, poles, or other bodies exposed to a flowing fluid. Also the body may be part of a vehicle, such as an exterior surface thereof such as portions of a ship or an aircraft, which may be a lighter-than-air, or heavier-than-air vehicle. The body may be part of a water-going vessel including hull surfaces, pontoons, airfoil surfaces, rudder surfaces, propellers and the like, as the use of the liquid infused surfaces may reduce the hydrodynamic drag forces. The body may be part of an aircraft, and the liquid infused surfaces may be used on any of the surfaces thereof, e.g, in particular any lift surfaces and/or flight control surfaces, such as wings, tail fins, flaps, rudders, and the like as the liquid infused surfaces may reduce the aerodynamic drag. The body may be part of a land vehicle, including but not limited to automobiles, trucks, trains, and the like. In particular the liquid infused surfaces can be advantageously adapted and be used upon high-speed vehicles such as automobiles, and especially high-speed train such a so-called “bullet trains” which encounter significant amounts of aerodynamic drag at higher speeds.

The liquid infused surfaces of the invention may also be used to provide an infused surface wherein the lubricating fluid is used to lubricate solid parts that come in contact with the infused surface. Coming into consideration are mechanical devices, and medical devices including artificial joints.

The lubricating liquid, as stated above, may be a single liquid or may be mixture or blend of different liquids that nonetheless respond to shear forces essentially as a homogenous single liquid composition. Similarly the bulk fluid, as stated above, may be a single liquid or may be a mixture blend of different liquids that nonetheless respond to shear forces essentially as a homogenous single liquid composition. Ideally the lubricating liquid and the bulk fluid differ from each other in that they exhibit one or more, preferably at least two of, and most preferably all the following characteristics (a) immiscible in the other said liquid, (b) are nonreactive liquids either with the other said liquid, (c) are essentially incompressible, (d) under steady-state flow conditions in which a shear force generated by the flowing bulk fluid against the infused surface containing lubricating liquid, preferably both the lubricating liquid and the bulk fluid are non-volatile, e.g, exhibit a low vapor pressure, (e) under steady-state flow conditions in which a shear force generated by the flowing bulk fluid against the infused surface containing lubricating liquid, the interfacial tension between the lubricating liquid and the bulk fluid is sufficiently high such that the lubricating liquid and the bulk fluid remain separate.

With regard to (a), it is preferred that the bulk fluid, and the lubricating liquid are immiscible with respect to each other. What is to be understood by immiscible is that these two liquids, after being intimately admixed (e.g., at room temperature, at 1 atmosphere) will ultimately, preferably within 24 hours, preferably less than 12 hours) separate into two separate liquid phases. Preferably the loss of any part of one liquid to the other liquid (i.e., the bulk fluid to the lubricant liquid, or from the lubricating liquid to the bulk fluid) is not more than about 5%, preferably not more than 1%, and order of increasing preference not more than: 0.9%, 0.8%, 0.7%, 0.6%, 0.5%, 0.4%, 0.3%, 0.2%, 0.1%, 0.05%, 0.001%, 0.001%, especially preferably 0%, under such mixing conditions. Most preferably, both the bulk fluid and the lubricating liquid are essentially immiscible at the conditions at their interface when the flowing bulk fluid contacts the liquid infused surface containing the lubricating liquid.

With respect to (b), it is particularly preferred that the bulk fluid, and the lubricating liquid, at the conditions at which the flowing bulk fluid contacts the liquid infused surface containing the lubricating liquid are non-reactive with respect to one another, such that the physical properties, including viscosity, temperature, and a density of the individual bulk fluid and the lubricating liquid are essentially constant at said conditions. In this way, it is ensured that the shear forces imparted by the flowing bulk fluid are essentially constant. Additionally, it is also preferred that wherein a plurality of individual liquids comprise the bulk fluid, and/or a plurality of individual liquids comprise the lubricating liquid in that, under the operating conditions at which the flowing bulk fluid contacts the liquid infused surface containing the lubricating liquid, that individual liquids comprised within the bulk and/or comprised within to the lubricating liquid remain nonreactive with respect to each other, such that the bulk fluid and the lubricating liquid also do not undergo an internal chemical reaction, which would impart a change in one or more of the physical properties, including viscosity, interfacial tension, temperature, and a density of the individual bulk fluid and the lubricating liquid. In all instances, neither the bulk fluid, or the lubricating liquid, should undergo a phase change, e.g, from a liquid to a solid form, or from a liquid to a vapor/gas form at the conditions at which the flowing bulk fluid contacts the liquid infused surface containing the lubricating liquid.

With regard to (c), both the lubricating liquid and the bulk fluid, when it is a liquid, are essentially incompressible. Such a characteristic feature avoids certain of the problems attendant upon prior art devices and systems in which a gas layer was utilized in order to reduce drag between a flowing bulk fluid, and a surface. By essentially incompressible is meant that an aliquot of the bulk fluid (liquid), or an aliquot of the lubricating liquid undergoes a volumetric loss of not more than 1%, and order of preference, not more than 0.1%, 0.01%, and 0.001%, most preferably 0.0001% when subjected to a pressure of 10 kPa as compared to the same aliquot's liquid volume at atmospheric pressure. Alternately, the lubricating liquid remains a liquid under the flow conditions of the bulk fluid in contact with the lubricating liquid.

With respect to (d) is preferred the both the bulk fluid, and that the lubricating liquid exhibit a low vapor pressure, at both atmospheric pressure, and also under the pressure which may be encountered at the interface between the flowing bulk fluid and the infused surface containing lubricating liquid under steady-state flow conditions of these two liquids. With such a requirement neither liquid would undergo a change in density under the operative steady-state flow conditions of these two liquids, which may undesirably alter the physical characteristics of one or both of the bulk fluid and/or the lubricating liquid. In this manner, the interfacial shear conditions relative to any point of contact between the flowing bulk fluid and the lubricating liquid present at such point will remain essentially constant under study-stay flow conditions of these two liquids, and would not be undesirably altered or disrupted due to the volatilization of a part of the flowing bulk fluid and/or the lubricating liquid. Alternately, the vapor pressure of the lubricating liquid is sufficiently low such that when in contact with the bulk fluid, the majority of the lubricating liquid remains within the infused surface.

As noted previously, preferably the bulk fluid and the lubricating liquid are essentially immiscible with respect to each other when in physical contact under the flow conditions described herein. While not essentially such may, for example be realized by the use of a hydrophobic (or oleophilic) or hydrophilic liquid as the bulk fluid, or as lubricating liquid, and having the complementary liquid, viz., hydrophilic or hydrophobic (oleophilic) as the remaining liquid. In this manner, the conditions of (a) immiscibility are easily provided. Virtually any hydrophobic liquid, and virtually any hydrophilic liquid, may be used in according with the present invention.

Alternately hydrophilic and/or hydrophobic (oleophilic) liquids are not necessarily required, as the present invention is applicable wherein the bulk fluid and the lubricating liquid may be maintained in different phases, e.g., liquid/gas, or liquid/liquid. For example in a liquid/gas system, the bulk fluid may be a gas, including compressible gases, or steam, while the lubricating liquid may be a liquid which has an affinity for the patterned surface and is retained thereon or therein. For example, in a liquid/liquid system, one or both of the bulk fluid and the lubricating liquid may be a liquid metal, silicone oil, the like.

Non-limiting examples of hydrophilic liquids include: water, aqueous mixtures comprising miscible organic solvents which retain hydrophilicity, such as water: C₁-C₈ monohydric alcohol mixtures (preferably water: C₁-C₄ monohydric alcohol mixtures) water:glycol mixtures, water:ether mixtures; water:glycol ether mixtures, and the like. In preferred embodiments however, the hydrophilic liquids comprise at least about 50% wt. water, more preferably are at least about 60% wt. aqueous, and especially preferably (in order to increasing preference) are: 85% wt., 86%% wt., 87% wt, 88% wt., 89% wt., 90% wt., 91% wt., 92% wt., 93% wt., 94% wt., 95% wt., 96% wt., 97% wt., 98% wt., 99% wt., 99.1% wt., 99.2% wt., 99.3% wt., 99.4% wt., 99.5% wt., 99.6% wt., 99.7% wt., 99.8% wt., 99.9% wt., 99.95% wt., 99.98% wt., 99.99% wt., particularly preferably 100% wt., water. The hydrophobic liquid may also contain no water, but be comprised of one or more liquids materials which have a high affinity to water, e.g., lower monohydric alcohols, e.g, C₁-C₄ monohydric alcohols, which may be used to provide a non-water containing hydrophilic liquid.

Nonlimiting examples of hydrophobic liquids include virtually any liquid which exhibits little or no aqueous solubility, and include, i.e., hydrocarbon oils, mineral oil, silicone oils, liquid metals, and other oleophilic materials. Essentially, any hydrophobic liquid may be used, and preferably such exhibit an aqueous solubility of not more than about 5% wt., and (in order of increasing preference), exhibit an aqueous solubility of not more than about 4.5% wt., 4% wt., 3.5% wt., 3% wt., 2.5% wt., 2% wt., 1.5% wt., 1% wt., 0.9% wt., 0.8% wt., 0.7% wt., 0.6% wt., 0.5% wt., 0.4% wt., 0.3% wt., 0.2% wt., 0.1% wt., 0.05% wt., 0.025% wt., 0.01% wt., 0.001% wt., and particularly preferably not more than 0.0001% wt., aqueous solubility. Essentially any hydrophobic liquid which is flowable under the conditions at which the bulk fluid contacts the infused surface containing the lubricating liquid may be used. Preferably the hydrophobic liquid includes not more than about 5% water, or more than about 5% of any other compound which exhibits an aqueous solubility of more than 50% wt.

Although the invention is believed to be operative with a bulk fluid which is only required to be flowable and a lubricating liquid which is required to be flowable (at least insofar only as may be required to introduce this lubricating liquid into the cavities present within the body), and that each of bulk fluid and the lubricant liquid may be a virtually any viscosity of each, optionally the viscosity of the lubricating liquid is equal to or greater than the viscosity of the bulk fluid, preferably at least about 3 times, more preferably at least about 5 times, and particularly preferably at least about 10 times (or even more) the viscosity of the bulk fluid.

The liquid infused surface is three-dimensional and comprises a surface having features adapted to retain the lubricating liquid therein/thereon under steady state flow conditions of the bulk fluid. Nonlimiting examples of such surface features are (preferably) recesses or cavities extending inwardly from the surface of the body and into the interior of the body (or surface). Another pattern of surface features are discrete protrusions extending upwardly from the surface. Another pattern may be a combination of both one or more recesses or cavities extending inwardly from the surface of the body and into the interior of the body, concurrently with one or more discrete protrusions extending upwardly from the surface of the body. Each of the surface features may be the same as others present, or may be dissimilar to others present. The dimensions of surface features may be uniform, or nonuniform. The placement and positioning of features upon surface may be in a random pattern, or may be in accordance with a regulated or repeating pattern. For example, where the features are a plurality of cavities, it may be advantageous to provide them in a regularly spaced apart pattern on the surface. Surface features may also be a pattern of random roughness present upon or within the surface.

In certain preferred embodiments, the features adapted to retain the lubricating liquid therein are a plurality of parallel channels formed into the body and extending inwardly from its surface, wherein the channels are from each other, and oriented in a parallel direction which is coincident with the direction of the flow of the bulk fluid. Reference is made to FIG. 1 which depicts a schematic representation of a single such channel 10 including certain flow conditions and parameters to be discussed hereinafter. FIGS. 1(b)-1(f) astray certain preferred embodiments of a patterned surfaces of bodies which comprise as features adapted to retain the lubricating liquid therein/thereon under steady state flow conditions of the bulk fluid, a series of parallel, channels 10 which are to be oriented in the longitudinal direction of fluid flow of the bulk fluid. The embodiment of FIG. 1(b) illustrates a surface 11 comprising a plurality of generally rectangular grooved channels 11 that extend between two ends 15. Each of the channels 15 have a base 13 that extends between two adjacent channel sidewalls 14, with cycles 14 extend upwardly to and terminate at the face 11. The base 13 has a width “w”, and each of the sidewalls have a height “h” extending between two ends 15. As is seen, an open face of each channel 10 is provided, which is coincident with the surface 11. In this embodiment, each of the dimensions of each channel 10 are equivalent, and they are uniformly spaced apart, and a parallel configuration with respect to each other. The embodiment of FIG. 1(c) depicts an alternative configuration selection of the prior figure. In this embodiment, the channels 10 are parallel, spaced apart from each other, however the dimensions of each of the channels may vary. Illustrated are four channels 10, each having different widths “w1”. “w2”. “w3” and “w4”, each of which may be different, or two or more may be of the same width. Each of the channels 10 have uniform height “h”, but this is not essential as is depicted in the next FIG. 1(d) which demonstrates that the channels 10 can have variations in their heights. “h”, “h1”, “h2” and or their widths “w1”, “w2”, “w3”, each which can be unique, or two or more of which can be the same dimension. FIG. 1(d) also depicts the length “L” of a channel.

The dimensions of the height and the width of a channel (or other “surface feature”) maybe used to provide an aspect ratio of the cross-section of the channel (or other “surface feature”) which may be a factor in establishing an ideal length, or maximum length “L”. Preferably the aspect ratio is in the range of about 0.1 to about 10, as where the height ‘h’ of the sidewalls of a surface feature, e.g. cavity or channel was greater than the width, there were negligible improvements to drag reduction observed.

The dimensions of the surface features are preferably microscale and/or nanoscale. Preferably when the features are microscale, the maximum size of the largest dimension of an individual surface feature is not more than 0.1 cm, preferably not more than 0.05 cm. When the features are nanoscale, the maximum size of the largest dimension of an individual surface feature are even less. Preferred dimensions are demonstrated with reference to one or more of the Examples.

In certain and according to particular preferred embodiments, the surface features additionally include at least one barrier which is a surface feature which alters the fluid flow characteristics of the bulk liquid transiting across the infused surface. Barriers may be physical barriers transverse to the lengthwise direction of flow of the bulk fluid, examples of which are depicted on FIGS. 1(e), 1(f) and 1(g). As is seen in these figures, and understood with reference to the prior figures, the lengthwise dimension of the channels 10 are interrupted by one or more physical barriers 18 which traverse the individual channels, and define fluid cavities extending between the ends 15 of a channel 10. Preferably, the top surface of each of the physical barriers 18 are coincident with the surface 11. The length of a cavity 10 may be established as described in more detail hereinafter.

FIGS. 1(f) and 1(g) provide a top plan view of surface features comprising a plurality of barriers 18 interrupting a series of parallel, spaced apart channels 10. The relative positioning of the barriers 18 is not critical with respect to an adjacent channel 10, and such does not need to be uniformly spaced in the transverse direction as shown in FIG. 1(f) but transverse spacing of the one or more barriers 10 can be offset, or staggered, as depicted in FIG. 1(g).

The physical dimensions of physical barriers, as illustrated in Figs. FIGS. 1(e), 1(f) and 1(g) is advantageously similar to the dimensions of the surface feature, here channels 10 such that the width of physical barriers is sufficient to extend between sidewalls of a channel and to occupy a cross-section thereof, with the top surface of the physical barrier preferably being coincident with the surface 11 such that the top surface of a physical barrier does not extend above surface 11. Conceivably, the top surface of the physical barrier can be lower than the level of the surface 11 and not be coincident there with, however most preferably both surfaces are coincident. While the width of the physical barriers between the end of one service feature, e.g, channel and the next (downstream) surface feature may vary, advantageously the width of the physical barrier is between about 1-100 microns, more preferably between about 1-15 microns.

The barriers need not be physical elements is illustrated in Figs. FIGS. 1(e), 1(f) and 1(g) but may also be patterned regions of different wettability transverse to the lengthwise direction of flow of the bulk fluid. Such may be regions of a surface feature, e.g., of a cavity or channel where its physical characteristics have been altered by a chemical or physical reaction. For example, a barrier may be established by reacting the surface such that it changes its hydrophobic or hydrophilic nature, or modifies the surface tension or affinity of the lubricating liquid present within the surface features such that lubricating liquid resists, or does not traverse this altered region. For example, as is discussed hereinafter, wherein the patterned surface is formed of a material which is hydrophobic, which may be preferred when the lubricating liquid is also hydrophobic in nature, then the altered regions of the surface are preferably wetting the bulk of the fluid over the lubricant in character, particularly wherein that the bulk fluid is a aqueous or highly aqueous in nature. In this way, lubricating liquid contained within the surface features are functionally “trapped” within a surface feature, and are retained within the surface feature that is bounded at one or more ends thereof by a an altered region which is hydrophilic in character. The dimensions of such an altered region are not necessarily critical, but must be sufficient to retard flow of the lubricating fluid across this altered region. Advantageously, when such an altered region is provided traversing a channel or a groove, then the maximum width of this altered region is approximately between 0.1-10 times the maximum width of the channel or groove which it traverses. Alternatively, and advantageously the width of the altered region is between about 1-100 microns, more preferably between about 1-15 microns.

Non-limiting examples of techniques that may be used to form the surface features of a pattered surface include: cutting, etching, milling, scribing, photolithography. 3D printing, lathing, laser ablation, imprinting, welding, folding, wrinkling, molding, spray coating, printing, abrasion, directional sanding, sand blasting, grinding, electrochemical machining, soldering, sanding, and attaching particles to the surface

Non-limiting examples of techniques that may be used to provide patterned regions of different wettability to a surface include printing, photoactivation (with a laser or through a mask), painting, joining dissimilar materials, spraying, drawing, etching through a coating,

Patterned surfaces of the invention may be ones wherein the surface features is/are a random roughness pattern could be created by, for example sand blasting or spray coating. Then, a pattern of physical barriers with a calculated spacing would be deposited over top of the random grid. This pattern could be deposited using, for example electrochemical methods or by extruding a material onto the surface (3D printing). Alternatively, a pattern of barriers could be chemical barriers that are made using, for example, painting or photoactivation.

Patterned surfaces may be ones having a more structured pattern could be created by, for example, scribing or directional sanding. Then, a pattern of physical or chemical barriers could be created to disrupt the continuity of the previously created pattern, allowing the lubricating liquid to be retained.

Patterned surfaces may be formed by imparting a compressive stress using either physical or chemical methods, that would generate a wrinkled or folded pattern. These wrinkles or folds would retain the liquid. The liquid continuity would be disrupted with barriers at a calculated spacing that are generated using either chemical or physical patterning.

Patterned surfaces may also be formed from porous materials to which may be imparted suitable surface features thereto. Such may include naturally porous material might automatically retain the liquid. Examples of such materials include solid foams, sintered metals and ceramics, sponges, fabrics, in which continuity of the cavities within these surfaces would then be disrupted through mechanical, optical, chemical or physical patterning.

Patterned surfaces may be inherently rough surfaces, such as may be formed through a casting process, heat treatment, or other process, to which may be imparted suitable surface features at a calculated spacing that are generated using either mechanical, optical, chemical or physical patterning.

Patterned surfaces may also be formed by weaving, using custom warp/woof design fabrics which provide a pattern of surface features. Such woven patterned surfaces may also incorporate different fiber types with which have different wetting properties, e.g., different affinities for the bulk fluid and lubricating liquid, which different fiber types, or regions or patterns of different fiber types, operate as surface features.

Patterned surfaces may also be formed by photografting or self-assembly techniques utilizing biomaterials and/or polymeric materials. For example polymers or biopolymers may be attached to a substrate which biopolymers are of a configuration, or have been customized with suitable moieties, e.g, which may form part of the polymeric backbone and/or be pendant moieties of the polymeric backbones wherein part of the polymers and/or biopolymers have a preferential affinity (“wetting”) for the bulk fluid, and other parts have a preferential affinity for the lubricating liquid.

Patterned surfaces may also be formed from electro-active polymers, which have alterable surface features depending upon the electrical state of the electro-active polymers. Such would allow for the configuration of the patterned surface to be reconfigured depending upon the change between electrical states.

Patterned surfaces may also be formed from shape-memory polymers which wrinkle in response to external pressure which could serve a similar purpose, by passively changing the length scales in response to flow. Such wrinkling would impart surface features to the patterned surface.

Certain preferred techniques are disclosed with reference to one or more of the following Examples.

For a bulk fluid, and for lubricating liquid, having known physical properties including viscosity, surface tension, and density, the dimensions of the patterned surface can be established there from by virtue of the following equation (Equation 1), wherein the steady-state length, L_{∝}, can be determined for a particular surface configuration.

$${L}_{∞} = ( \frac{{c}_{p} h}{{c}_{s} {r}_{min}} ) \frac{γ}{{τ}_{yx}} \qquad Equation 1$$

wherein:
h is the height of the cavity,
rₘᵢₙ is the minimum radius of the interface curvature
γ is the surface tension of the interface between the two liquids,
τ_{xy} is the interfacial shear between the two liquids in the direction of flowing liquid,

$${c}_{s} = \frac{1}{2} - \frac{4 h}{w} {\sum }_{n = 0}^{∞} \frac{{( - 1 )}^{n}}{{λ}_{n}^{4}} tanh ( \frac{{λ}_{n} w}{2 h} )$$

Depends upon the aspect ratio of the width to height of the cavity,

$${c}_{p} = \frac{1}{3} - \frac{4 h}{w} {\sum }_{n = 0}^{∞} \frac{{( - 1 )}^{n}}{{λ}_{n}^{5}} tanh ( \frac{{λ}_{n} w}{2 h} )$$

in each of which:
h is the height of the cavity,
w is the width of the cavity,
λₙ=(n+½)π

This calculated value of L_{∝} provides a maximum theoretical length limit for the distance between successive barriers (physical barriers, and/or regions) present in the flow direction of the bulk fluid, and advantageously, the distance “L” (see FIGS. 1(f), 1(g)), or alternately when the surface features cavity, groove, or channel, L_{∝} provides a maximum theoretical length limit for the longest dimension, e.g, actual length, which may also be the maximum length of the distance between barriers and/or patterned regions of different wettability at ends of a cavity of the infused surface. Advantageously, the actual length “L” is not greater than the steady-state length. L_{∝}, (thus, L≦L_{∝}) and more preferably, the actual length “L” is less than the steady-state length, L_{∝}, (thus, L<L_{∝}), and critically preferably, the actual length “L” has a value of from about 0.05·steady-state length, L_{∝}, and about 0.95·steady-state length, L_{∝}. In this manner, under steady-state flow conditions of a bulk fluid traversing the infused surface having surface features which retained the lubricating liquid, when the above conditions are met the interfacial shear has little likelihood to empty or drain in the lubricating liquid from the infused surface.

Equation 1 is facilitated by the calculation of the following further Equation 2 which provides an initial assessment of the projected drag reduction “DR” for patents surface having surface features of a particular geometry and/or dimensions.

$$DR = a - \frac{a}{{DNb}^{+}} \sqrt{\frac{25}{1 + \frac{5}{{DNb}^{+}}}} arc tanh ( \sqrt{\frac{1}{1 + \frac{5}{{DNb}^{+}}}} ) \qquad Equation 2$$

wherein:
DR is the drag reduction,
a is the lubricant area fraction,
b is the cavity width,
D is the depth of the cavity vortex normalized by b,
N is the viscosity ratio between the external fluid and the liquid,
b+≡b/η, with η≡v/uτ and uτ≡√(τw/ρ), in which
v is the external fluid viscosity.
uτ is the friction velocity.
   τw is the viscous shear stress at the interface between the bulk fluid and the lubricating liquid,
   ρ is the external fluid density.

Certain parameters of the above Equation 1 and Equation 2 are illustrated with reference to FIG. 1 that illustrates a single cavity containing a quantity of lubricating liquid in a condition wherein excessive shear is being imparted thereon by the flowing bulk fluid.

A skilled artisan may utilize the results arrive from Equation 2 to first assess the theoretical drag reduction for a particular bulk fluid, a particular lubricating liquid, and for a particular service feature or patterned surface to initially establish if a desired degree of drag reduction is achieved. Drag reduction may be as little as 0.001% or may be a greater number, preferably is a value at least 0.1% or more. If an insufficient degree of drag reduction is calculated from Equation 2, the skilled artisan should then alter one or more of the variables, e.g., the dimensions of one or more of the surface features of the patterned surface, and/or the bulk fluid and/or the lubricating liquid, and recalculate Equation 2. When a suitable or desired degree of drag reduction is ultimately calculated, the parameters used to calculate Equation 2 may, as appropriate, be used to determine the theoretical steady-state length, L_{∝}, of the patterned surface, from which the value “L”, may be established. Broadly speaking, and such a manner the present invention provides methods for designing and fabricating liquid infused surfaces which feature reduced drag characteristics.

The present invention also provides a method for increasing the operating efficiency of systems in which a flowing bulk fluid is in contact with a patterned surface, the increased operating efficiency specifically being realized from a reduction of the drag forces between the flowing bulk fluid and the patterned surface. The foregoing Equations 1 and 2 may be used to determine a suitable surface pattern which can be used to infuse and retain a lubricating fluid, which surface pattern can be incorporated, provided calmer applied to a surface of a body in order to reduce the drag forces of the surface (and the body). Existing surfaces and/or bodies of articles, vehicles. etc. can be modified in order to include a suitable surface pattern, which is adapted to retain the lubricating fluid under steady state flow conditions with the bulk flow fluid thereby reducing the drag forces between the flowing bulk fluid and the patterned surface.

The calculation of drag reduction from Equation 2, and the theoretical steady-state length, L_{∝}, of the patterned surface from Equation 1, provides a method of fabricating liquid infused surfaces which feature reduced drag characteristics for a lubricating liquid and a bulk fluid. According to the method, suitable dimensions can be established for the configuration of one or more cavities to be produced within a body and below the surface of the body by determining for a lubricating liquid to be retained within the one or more cavities present below the surface, and for a bulk fluid to be in flowing contact with the surface and with the exposed lubricating liquid, one or both of:
(a) the drag force present at the interface of the exposed surface of lubricating liquid and the flowing bulk fluid which is determined from Equation 2; and/or
(b) the maximum satisfactory length of what more the cavities present within the body which cavities contain (or are adapted to contain) a quantity of the lubricating liquid, under steady-state flow conditions of the bulk fluid flowing across the surface of the body, which is determined from Equation 1.

### EXAMPLE 1

A microfluidic flow cell was constructed from transparent epoxy (Norland Optical Adhesive (NOA 81)) according to the methods disclosed by D. Bartolo, et al. Lab Chip 8, p. 278 (2008) with a patterned surface imprinted on a section of its floor as disclosed in FIGS. 2(a)-2(d). The surface pattern in this experiment consists of 50 streamwise grooves each with width w=8.8-9.2 μm and height h=10.0 μm [see FIG. 2(d)] that end upstream in a 1 by 1 mm well of equal depth to create the open end as shown schematically in FIG. 1. The pattern was initially filled with silicone oil mixed with fluorescent dye (viscosity μₒ=42.7 or 201 mPa s), and connected to a downstream reservoir of oil at the terminus of the flow cell. The external aqueous fluid (a 1:1 wt mixture of glycerol and water, viscosity μ_{aq}−5.4 mPa s) entered the upstream inlet of the device (see FIG. 2(a)), and exited through a slot-shaped outlet that is upstream of the terminus. This configuration ensured that the draining oil did not block the flow of the external phase, and that the external flow was not constricted as it exited the device. The flow cell (height H=180 μm and width W=7 mm) was thin but still much deeper than the pattern, so that the flow profile was approximately parabolic through its depth and uniform through its width. Thus, a flow rate Q imposed a shear stress

τ_{yx}=6μ_{aq}Q/WH²

on the pattern. Using microfabricated grooves to study lubricant drainage ensured a controlled and reproducible surface topography that was invariant in the streamwise direction, thereby providing a system amenable to a fluid dynamical description.

The behavior of the oil phase was observed using fluorescence macrophotography. A time series of photographs from a typical experiment is depicted in FIG. 2(c), demonstrating the characteristic drainage behavior: under the influence of shear from the aqueous phase, the oil in the upstream portion of the pattern dewetted first, with a dewetting front that propagated downstream. The front initially propagated rapidly, before slowing and eventually stopping at a steady-state streamwise position; the length of fluid retained in the pattern between this final front location and the slot-shaped outlet is defined as the steady-state length L_{∞} [also, see FIG. 2(c)].

Since the streamwise grooves terminated in a fluid reservoir, there was no physical barrier to drainage of the oil, and thus the existence of steady-state oil retention initially seemed nonintuitive. To clarify the mechanism that leads to oil retention, identical experiments were performed using a confocal microscope, and the steady-state configuration of the oil at the scale of the pattern itself was observed. Cross-sectional (yz-plane) images of the steady-state oil distribution were taken at regular intervals in the streamwise (x) direction along the length of the filled portion of the groove. Two representative images are shown in FIGS. 3(a) and 3(b). The fluorescent oil (31) was index matched with the solid so that the interface between the oil or solid and aqueous phase (32) was visible in reflection The oil-aqueous interface (32) is deflected inward towards the substrate and appears to have a constant curvature κ in the cross-sectional (yz) plane. Because the length of the filled portion of the groove is much longer than the width or height of the groove, this cross-sectional interfacial curvature dominates over curvature in the streamwise or wallnormal (xy) plane. The pressure drop across a curved liquid-liquid interface is equal to κ multiplied by the surface tension of the interface γ. Since the interface is deflected inwards, the pressure is lower in the oil than in the aqueous phase. Thus, the pressure within the oil decreases in the direction opposite the flow of the external phase. This adverse pressure gradient drives recirculation of the oil trapped in the groove, countering the external shear stress, and provides the physical mechanism for a steady-state wetting configuration under shear.

This explanation of the lubricating liquid retention mechanism upon or within the patterned surface and within and/or between surface features present upon or within the surface rests on a number of assumptions about the system: the Reynolds number in the lubricating liquid

ρₒτ_{yx}h²/μₒ²<<1

indicating negligible inertial effects, and the Bond number

w²g(ρ_{aq}−ρₒ)/γ<<1

which indicated that gravity is negligible.
These assumptions apply to most applications of liquid infused surfaces. Long-range forces (such as van derWaals) were ignored; though this assumption is valid for the microscale patterns of the current experiment, long range forces may be relevant for certain chemistries on surfaces with nanoscale geometries. Finally, there was assumed that

μₒ>μ_{aq},

so that the shear stress imposed by the aqueous flow is effectively unchanged by the oil. The adverse pressure gradient driving oil in the upstream direction [see FIG. 1] depended on the gradient in the curvature of the interface over the length of the groove. At the downstream end, where the aqueous fluid exits the flow cell, the interface was flat, indicating a zero pressure drop across the interface. At the upstream end, the minimum radius of curvature rₘᵢₙ was determined by the groove width w and the receding contact angle θ or, for wider grooves, the aspect ratio of the groove w/h. The interfacial deflection at the groove center δ varies as δ□x between these two limits, as shown in FIG. 3(c). Since δ□κ for small deflections, dκ/dx is approximately constant, indicating that the pressure gradient within the lubricating liquid is essentially constant.
A quantitative model to predict the dynamics of drainage from the grooved patter based on the flow reversal mechanism was inferred from interfacial measurements was constructed, which model is useful in predicting the evolution of the wetted length of the groove L(t) under the action of an applied shear stress τ_{yx}. The most direct approach to determining L(t) was the development of a volume-balance conservation equation for the flux of lubricating liquid out of the groove.

The time derivative of the volume of lubricating liquid in a groove of filled length L(t) was given by c_{d}whdL/dt, where c_{d} is a constant that depends on the aspect ratio of the groove w/h, and represents the average fraction of the groove's cross-section wh that is lubricating liquid filled. This time derivative must equal the sum of the downstream flux of oil driven by shear and the upstream flux of oil driven by the pressure gradient. The lubricating liquid flux induced by a shear stress τ_{yx} is given by −cₛτ_{yx}wh²/μₒ, where the sign indicates that the flux acts to decrease the volume of lubricating liquid in the groove. The constant cₛ depends on the aspect ratio w/h, and accounts for the hydrodynamic resistance imposed by the walls and floor of the groove. The flux of lubricating liquid driven upstream by the pressure gradient can be related to the change in interfacial curvature over the wetted length of the groove, as described above. The total pressure drop is proportional to 1/rₘᵢₙ; the pressure gradient was distributed along the oil-filled length and is therefore proportional to 1/L. Thus, the pressure driven recirculation flux is given by cₚwh³γ/(μₒrₘᵢₙL), where cₚ is another hydrodynamic resistance constant dependent on w/h. Summing these three terms to enforce volume conservation yielded the following equation:

$${c}_{d} wh \frac{d L}{d t} = - \frac{{c}_{s} {τ}_{yx} {wh}^{2}}{{μ}_{o}} + \frac{{c}_{p} {wh}^{3} γ}{{μ}_{o} {r}_{min}} \frac{1}{L}$$

The steady state length of lubricating liquid was found by setting the left hand of the foregoing equation equal to zero, which yielded the following equation for the steady state length of lubricating liquid in the groove:

$${L}_{∞} = ( \frac{{c}_{p} h}{{c}_{s} {r}_{min}} ) \frac{γ}{{τ}_{yx}}$$

where the prefactor contains all effects of the groove geometry. Thus, L_{∞} is a shear-driven equivalent to the classical capillary rise height, and results from the ability of patterned surfaces to wick wetting fluids.

The foregoing model for groove drainage was validated against macroscale measurements of how the wetted length of the grooved changed as a function of time. FIGS. 4(a) and 4(b) illustrate and how the non-dimensional scales collapse both drainage trends towards the universal theoretical prediction; an important consequence of which is that the steady-state length does not depend on the viscosity of fluid in the groove μₒ. FIGS. 4(a) and 4(b) depict drainage curves for grooves of a single fluid, at different flowrates, plotted his length versus time with dimensional results illustrated in FIG. 4(a), and nondimensional results illustrated in FIG. 4(b). In the figures, the curves (41) represent a an oil used to infuse the test cell, under a flow rate of Q=2 mL/minute through the cell, curves (42) represent the same low viscosity oil used to infuse the test cell, under a reduced flow rate of Q=1 mL/minute, and curve (43) represents the theoretical prediction. FIGS. 4(c) and 4(d) depict drainage curves for grooves of a two fluids of different viscosity but both at a flow rate of Q=2 mL/minute through the cell, at plotted his length versus time with dimensional results illustrated in FIG. 4(c), and nondimensional results illustrated in FIG. 4(d). In these latter figures, curve (41) represents the same low viscosity oil used in conjunction with FIGS. 4(a) and 4(b), curve curve (44) represents a higher viscosity oil having a viscosity at least one order of magnitude greater than the low viscosity oil of curve (42), while curve (43) represents the theoretical prediction. Each of curves (41), (42), (43) and (44) represent the average wetted length of defect-free grooves in the cell used in the experiment. The reported results, depicted on FIGS. 4(a)-4(d) are average results from a number of individual experiments under the specific conditions tested.

The indicator results confirmed that μₒ was a useful design parameter in the construction of liquid infused materials without influencing the oil retention properties. As is depicted on FIGS. 4(c) and 4(d), despite the different drainage rates between two oils, the steady-state wetted length were roughly the same.

It was also observed that the steady-state length L_{∝}, was independent of group size, and depends only on surface tension, and contact angle (through rₘᵢₙ) and groove aspect ratio. As surface tension contact angle are inherent functions of the fluids, and cannot be considered adjustable parameters, the aspect ratios of grooves w/h is a primary means of controlling the retention of lubricating liquid (in the experiment, viscous hydrophobic oil) in the infused surface, subjected to an interfacial shear from a flowing bulk fluid.

### EXAMPLE 2

Further experiments were undertaken in order to evaluate flow characteristics of liquid infused surfaces similar to those previously described with reference to Example 1 albeit with different configurations of the surface of the test cells than those of Example 1. In most other respects the current experiments were substantially similar to or identical to that described in Example 1.

In the current Example, the entire microfluidic device, including the roughness microstructure, was molded from Norland Optical Adhesive (NOA 81) using the ‘sticker’ technique disclosed by D. Bartolo, et al. Lab Chip 8, p. 278 (2008) with a patterned surface. The flow cells were 7 mm wide by 180 μm deep, and 45 mm long, with the roughness pattern positioned near the spanwise center of the device. There was an inlet port at the upstream end of the device, and two ports at the downstream end: one filling port far downstream at the terminus, and a second slot-shaped port that served as the outlet and is 10 mm upstream of the terminus. See FIG. 2(a). The micro-pattern was 36 mm long, and was located such that the downstream ends of the grooves lay at the downstream terminus of the flow cell.

The flow cell geometry was molded out of the epoxy onto a piece of glass with dimensions 25×75×2 mm (black glass was used to block background fluorescence in the experiments). The roughness pattern was molded out of epoxy on a clear glass No. 1 coverslip of dimensions 24×60 mm, before the flow cell and pattern were stuck together. To create the pattern used for the flow cell, a negative of the geometry was cut from a sheet of adhesive Kapton film (thickness 180 μm) using a laser cutter. The adhesive pattern is then stuck onto a 4″ diameter silicon wafer. Photolithography and deep reactive ion etching (Bosch process, 46 cycles) were used to etch the roughness pattern into a separate silicon wafer. An inverse mold of both patterns was created using PDMS (Sylgard 184), and then the epoxy was molded from the PDMS. To ensure high fidelity, the PDMS molds that were used for the micropattern were degassed under vacuum overnight before each use and cleaned with a 1 M solution of NaOH after each use. Holes and slots were drilled into the black glass using a diamond-coated bit prior to molding. During the molding process, the holes are partially blocked with HDPE tubing, and the slot is filled with a strip of HDPE (254 μm thick, 9 mm wide). The HDPE did not stick to the epoxy and was removed after curing, to create the ports. The circular ports were trimmed with a countersink drill bit, and the slot-shape port was manually trimmed with a razor blade. Then, the channel side was plasma treated for five minutes to make it hydrophilic and prevent oil drops from adhering to that side. The cure time of the patterned slide was set so that the epoxy remained slightly tacky. Then, the two epoxy-glass laminates are pressed together to create the microfluidic device. Inlet and outlet tubing was inserted into PDMS blocks that were hole-punched and then bonded to the black glass above the pre-formed holes in the epoxy.

During the experiment, macroscale imaging was provided by unique setup allowing for the imaging of the oil in the grooves with resolution range which permitted for a resolution range from as small as the width of one groove (10 μm), but with a field of view as large as the whole device (45 mm). The microfluidic device was placed upside down and illuminated with an array of LEDs with peak wavelength 395 nm. The device was imaged from above with a vertically-mounted Nikon D90 DSLR camera outfitted with a Nikon AF Micro-Nikkor 200 mm lens and a Tiffen Yellow 8 filter (Wratten 8 transmission spectrum) which blocks the excitation light but transmits the fluorescence from the UV dye. During such imaging, the test cell was enrobed in black fabric to block external light to provide improved images.

Microscale imaging was provided during the experiments by the use of a Leica TCS-SP5 confocal microscope was used to capture the images of the groove cross-sections (63× oil objective, 514 nm laser). The y-location of the interface was determined entirely from the peak in reflection intensity so as to eliminate any ambiguity in data processing. The index of refraction of the oils is closely matched to the index of refraction of the solid, which in turn is closely matched to the index of refraction of the immersion oil of the microscope.

As the bulk fluid was used of a 1:1 weight mixture of glycerol and water, with a viscosity of μ_{aq}=5.4 mPa·s and density of ñ_{aq}=1.125 g/mL.

As the lubricating liquid, used to infuse the test cell and the micro-pattern were used two different silicone oils with high index of refraction (a) 1,1,5,5-tetraphenyl-1,3,3,5-tetramethyltrisiloxane (Gelest PDM-7040), with viscosity μₒ=42.7 mPa·s, density ñₒ=1.061 g/mL, and an interfacial tension with the aqueous solution ã=29.0 mN/m; and, (b) 1,1,3,5,5-pentaphenyl-1,3,5-trimethyltrisiloxane (Gelest PDM-7050) with o=201 mPa·s, ñₒ=1.092 g/mL, and ã=28.2 mN/m. For both oils (a) and (b), the receding contact angle θ=56±4′. The oils were either 5.3 or 37 times more viscous than the bulk fluid, and is also immiscible and nonreactive therewith. These two oils were chosen because their index of refraction is close to that of the epoxy that is used to construct the microfluidic device, and because silicone oils are less susceptible to contamination from surface-active components than hydrocarbon oils. To aid in visualization for the macro- and micro-scale experiments, the oils are mixed with Tracer Products TP-4300 UV Fluorescent Dye in a volume ratio of 1000:2.

The aqueous solution is pumped into the device using one or two 140 mL syringes mounted on a syringe pump (Harvard Apparatus, PHD-2000) which provided for a high degree of control over the flowrate. The flow of the glycerol:water solution across the patterned surface comprising the infused liquid generated the interfacial shear stress.

At the beginning of an experiment, the entire device (see FIG. 2(a)) was first filled with oil through the filling port at the flow cell terminus; this port was then clamped shut with locking forceps and the aqueous solution was pumped into the inlet at 2.5 μL/min. slowly clearing the bulk oil from the portion of the device between the inlet and the outlet slot, but leaving the oil infused in the pattern as a lubricating liquid. Next, the clamp was switched from the filling port to the outlet slot, so that the interface between the oil and aqueous solution retreated towards the flow cell terminus. When the interface reached a location midway between the outlet slot and the terminus, the clamp was switched back to the filling port, so that the interface halted, a reservoir of oil was established at the terminus, and the flow of the aqueous solution was redirected back to the outlet slot.

It was observed that under steady state flow conditions, the shear stress from the flow of the external aqueous solution drags the oil downstream. At the fluid-fluid interface, the velocities and shear stresses in the two phases were equal. However, since the depth of the flow cell is much greater than the depth of the groove, and the trapped oil is more viscous than the aqueous solution, the velocity of the former is assumed negligible compared to typical velocities in the latter. The flow of the aqueous solution can therefore be considered unperturbed by the presence of a non-solid boundary; it passively imposes a shear stress. τ_{yx}, on the trapped oil. Thus, the steady state length was determined from the equation:

$${L}_{∞} = \frac{{c}_{p} h}{{c}_{s} {r}_{min}} \frac{γ}{{τ}_{yx}}$$

In the present Example, there were evaluated the following further patterned test surfaces according to the protocol described supra.

| pattern | length | height | width |
|---|---|---|---|
| A | 36 mm | 8.8 μm | 4.7-4.9 μm |
| B | 36 mm | 9.3 μm | 9.9-10.1 μm |
| C | 36 mm | 9.7 μm | 19.7-20.0 μm |
| D | 36 mm | 10.0 μm | 39.4-39.6 μm |
| E | 36 mm | 18.9 μm | 11.1-11.7 μm |
| F | 36 mm | 20.4 μm | 20.7-20.9 μm |
| G | 36 mm | 21.4 μm | 40.7-51.1 μm |

Each of the further patterned test surfaces comprises 50 streamwise cruise of the foregoing indicated dimensions, and were initially filled with the low viscosity oil and thereafter evaluated against the 1:1 glycerol:water solution at a flowrate of Q=2 ml/min.

### EXAMPLE 3

A liquid infused surface which included patterned regions of different wettability were produced and evaluated in a microfluidic device. (See FIG. 5(a)) The liquid infused surface was constructed from Norland Optical Adhesive, a UV-cured epoxy, following the microfluidic sticker technique according to the methods disclosed by D. Bartolo, et al. Lab Chip 8, p. 278 (2008). The test surface had a depth H=180 μm, a width W=7 mm, and a length of 45 mm. Fifty parallel grooves were provided to the test surface, each groove having a width w=8.8-9.2 μm, a depth h=10.0 μm, and are 35 mm long, each separated from the adjacent groove by a wall having a width of 11.8-12.2 μm, for a total width of 1 mm between the outermost grooves. See FIG. 5(b). The pattern was positioned near the spanwise and streamwise center of the flow cell. Since the flow cell was very wide, with an aspect ratio of 40:1, and was much deeper than the pattern, the flow profile of the bulk fluid was approximately uniform through the width of the flow cell and parabolic through its depth. The infused liquid (lubricating liquid) was silicone oil (Gelest PDM-7040, viscosity μₒ=43 mPa s) mixed with 0.2 vol % fluorescent dye (Tracer Products, TP-3400), and the outer aqueous liquid (bulk fluid) was a 1:1 weight mixture of glycerol and water (u=5.2 mPa s). The surface tension between the two phases was γ=29 mN m¹. The outer fluid, was pumped with a syringe pump at a flow rate Q, imposed a shear stress of approximately τ=6μ_{aq}Q/WH² on the grooved test surface.

Patterned regions of different wettability (as shown as (51) in FIG. 5(b) were formed into the test surface as follows. As Norland Optical Adhesive is naturally slightly hydrophobic, such permitted for surface modification in select regions to create the desired sacrificial regions of hydrophilicity. We use a method (disclosed by B. Levache, et al. Lab Chip. 12, 3028-3031 (2012)) that relies on deep-UV exposure to modify the surface chemistry and make the epoxy hydrophilic. The deep-UV exposure might also change the roughness of the surface, but these effects would be subsumed in the measured contact angle. The hydrophilic regions were defined precisely through the use of a photomask. To create a photomask with micron-scale pattern geometry, a 100 nm layer of chromium was sputtered onto a bare quartz wafer; quartz is transparent in the deep-UV range. A 500 nm layer of photoresist was then spin-coated onto the quartz, before being selectively exposed and developed. Subsequently, the wafer was etched with a chromium etchant, so that unprotected regions of the chromium were dissolved. Then, the hardened photoresist was removed, leaving only the chromium photomask bonded to the quartz wafer.

The microfluidic flow cells were molded in two separate halves—an upper half with the flow cell geometry and a lower half with the grooves—before being bonded together to create a closed flow cell. Before the two sides were sealed, but after the epoxy was cured, the grooved side of the flow cell was exposed for 30 minutes under the photomask in a deep-UV lamp (Jelight bulb, intensity 30 mW cm² at 253.7 nm). For the experiments presented herein the mask has transparent stripes that are 3 mm long and 250 tm wide, running across the texture with a stream-wise period of 8 mm. Thus the hydrophobic untreated regions had an approximate length of L=7.75 mm as shown in FIG. 5(a). The mask was elevated 100-200 μm above the surface of the epoxy during the patterning step, because the mask was found to damage the surface texture if it contacted the epoxy. This offset resulted in hydrophilic regions (51) (see FIG. 5(b)) with diffuse boundaries, as well as minor variations in the geometry of the hydrophilic regions due to a non-uniform gap height. After the hydrophilic treatment the two sides of the flow cell were bonded together and the flow cells are left in an oven at 70° C. overnight prior to being used.

To image the drainage dynamics over the length of the patterned test surface, the flow cells were mounted upside-down under a Nikon D90 camera outfitted with a 200 mm f/4 macro lens. The flow cells were illuminated with 470 nm blue LEDs that cause the oil to fluoresce. Since the fluorescence from the oil was rather weak, a number of steps are taken to enhance the image quality: a photographic filter was mounted on the lens to block the excitation light (Wratten 12 transmission spectrum), the flow cells were molded with black glass on the back side to block background light, and black fabric was wrapped around the whole setup to block light from the room.

At the beginning of an experiment, the entire flow cell was first filled with the silicone oil. The silicone oil (lubricating fluid) infused the patterned surface texture, including regions that were treated to be hydrophilic, because these regions are also lipophilic in the presence of air. Then, the external aqueous:glycerine solution (bulk fluid) was slowly pumped into the device at 5 μL min¹, corresponding to a calculated shear stress of τ=1.2 10³ Pa. The aqueous solution displaced the oil from the main portion of the channel, leaving the oil trapped in the unexposed hydrophobic regions of the grooves. As the aqueous-oil interface reached an exposed hydrophilic region (51), however, the aqueous solution displaced the oil from the hydrophilic region and preferentially wetted this region. Thus, portions of the grooves which are located between hydrophilic regions are functionally disconnected from one another. This wetting state is shown in FIG. 5(b), showing a part of the patterned surface (54) of the flow cell (50), depicting parts of two grooves (52) extending in the flow direction of the bulk fluid (as illustrated by the arrow “external flow, T”) including exposed hydrophilic regions (51) traversing the grooves (52), and further showing the lubricating liquid (53) within the grooves (52) but not in the hydrophobic region (51). After the main portion of the flow cell has been cleared of its initial oil (lubricating fluid) the flow rate of the aqueous solution (bulk fluid) was increased rapidly to a much higher level.

Experiments were performed at shear stresses of τ=4.8 and 19.0 Pa, which are below and above the estimated critical (shear stress) value of 12.2 Pa. Steady-state images from these two experiments are shown in FIG. 6a and FIG. 6b, each having a series of exposed hydrophilic regions (51) traversing the grooves spaced apart at L=7.75 mm, wherein in FIG. 6(a) the stress τ=4.8 Pa, and in FIG. 6(b) the stress τ=19.0 Pa. It was found that on a surface with patterned wettability, the oil resisted drainage entirely when exposed to the lower shear stress, as is seen from comparing FIG. 6(a) with FIG. (6b), in the latter the lower part of the figure includes reduced area which retains the infused lubricating liquid (oil), as at the higher shear stress, roughly half of each hydrophobic region was drained of oil.

For comparative purposes, control cases are shown in FIG. 6© and FIG. 6(d), where untreated textures, viz, those having no exposed hydrophilic regions (51) were subjected to the same experimental conditions and the same shear stress values. In both of these latter “control” experiments, a significant portion of the texture was drained entirely of oil, indicating that a pattered surface which comprised exposed hydrophilic regions, especially exposed hydrophilic regions transverse to the direction of fluid flow across an infused surface comprising a lubricating liquid successfully prevents shear driven-drainage below a design-limited shear stress threshold, according to the following equation:

$$L < \frac{2 {c}_{p} h γ}{{c}_{s} w τ} ( 1 + \frac{w}{2 {r}_{min}^{u}} ) ,$$

where:
L is the length of continuous wetted regions,
cₚ and cₛ are dimensionless functions of the groove aspect ratio, w/h,
and rₘᵢₙ^{u} is a length scale that is a function of w, h, and the receding contact angle θ_{rec}, as when the foregoing equation is satisfied, the infused liquid should be stable and not drain from the infused surface due to the interfacial shear force of the flowing bulk fluid.

### EXAMPLE 4

A liquid infused surface which included patterned regions of different wettability were produced and evaluated in a microfluidic device. (See FIG. 5(a)) The liquid infused services were evaluated for their resistance to retain their lubricating liquid under gravity induced shear conditions, and wherein no external shear force was applied by a bulk flowing liquid. Rather, ambient air was in contact with the surface of the infused liquid.

As a test substrate was used a hydrophilic acrylic plate was used as the body of a test cell, onto which was spray coated with stencil a hydrophobic spray, which resulted in the deposition of regions of different wettability on the surface of the acrylic plate.

The acrylic plate was milled to have a series of parallel grooves cut into its body from a flat surface. The grooves were milled to have width w=0.51 mm and depth h=0.51 mm, running along the entire length of a 100 mm×150 mm piece of black acrylic. The infused liquid used in the experiment was a 5:1 weight mixture of glycerol and water, mixed with 0.1 wt % fluorescing sodium salt (ρ_{aq}=1.125 g mL⁻¹, μ_{aq}=52 mPa s, γ=66 mN m¹).

The initial estimated threshold for initial gravity-driven drainage of the liquid from the groove, and the stability criteria therefore was determined from the following equation:

$$L < \frac{2 γ}{{ρ}_{aq} gw} ( 1 + \frac{w}{2 {r}_{min}^{u}} ) ,$$

where
L is the length of continuous wetted regions,
g is the force of gravity,
cₚ and cₛ are dimensionless functions of the groove aspect ratio, w/h,
and rₘᵢₙ^{u} is a length scale that is a function of w, h, and the receding contact angle θ_{rec}.
When the foregoing equation is satisfied, the infused liquid should be stable and not drain from the infused surface due to gravitational force imparted on the infused liquid.

Based on the inherent physical characteristics of the material selected for the lubricating fluid (aqueous glycerol solution (5:1)) and air (which functions here as the flowing bulk fluid), the above equation provided a value of L=46 mm, the theoretical internal between regions of regions of different wettability. To evaluate this predicted value, two samples of acrylic plates having desired patterns of hydrophilicity hydrophobicity were produced from previously milled acrylic plates. Each of the plates was treated to impart regions of different wettability (51) extending transverse (and into) the milled grooves, on one plate the regions of different wettability (51) where as distances of L=25 mm, and on the other the regions of different wettability (51) were spaced apart at distances of L=50 mm. The former value was well below the calculated value of L=46 mm, the latter value being slightly greater than the calculated value of L 46 mm. Additionally, as a “control” and further acrylic plate, also from the previously milled acrylic plates, was used without any surface treatment to impart a regions of different wettability.

To create the desired patterns of hydrophilicity and hydrophobicity, the milled acrylic plates was first thoroughly cleaned using isopropyl alcohol, followed by rinsing with water. The milled surface was then treated in an oxygen plasma chamber for 10 minutes to make it hydrophilic. To create the hydrophobic design on the acrylic plates, 1 mm thick glass microscope slides were placed over the acrylic to act as a stencil, and the glass-acrylic sandwich was spray-coated with Penguin Water & Stain Repellent. The glass microscope slides were placed such that they covered either 25 mm or 50 mm long sections of the groove, with a 2 mm exposed gap between the sections—the acrylic beneath the gap would then become hydrophobic. In order to ensure that the sprayed regions were uniformly coated, and to prevent leakage of the hydrophobic spray under the glass, the acrylic was lightly sprayed repeatedly (approximately 15 times) with 10 second intervals between each spray, which allowed for the spray to evaporate between repetitions and prevented pooling. The glass slides were then removed and the treated acrylic was allowed to dry in an oven at 70° C. for 30 minutes.

During the experiment, each of the acrylic substrates was mounted on a stand that allowed it to be quickly rotated between a horizontal and a vertical position. While the acrylic was in the horizontal position, 1 mL of aqueous glycerol solution (5:1) was distributed across one end of the texture using a syringe. The solution was then pushed along the grooves using a squeegee at approximately 20 mm s¹ to allow the grooves to fill with liquid. The solution only filled the hydrophilic sections of the grooves and was repelled by the hydrophobic sections, as depicted on FIGS. 8(a) and 8(b), the latter being a closeup of the former figure. Occasionally the solution did not initially enter the hydrophilic sections, and the process was repeated until all hydrophilic sections of the grooves were filled. Drainage was initiated by quickly flipping the acrylic to the vertical position. The setup was imaged using the same macroscale fluorescent imaging as described before with reference to Example 3 supra.

The results from the foregoing evaluation of the three samples of acrylic substrates are illustrated on FIGS. 8(a). 8(b) and 8(c) (the “control”). FIG. 8(a) illustrates good retention of the infused lubricating fluid (53) within the groove, when the group was interrupted by several transverse regions of different wettability (51), spaced apart by L=25 mm. FIG. 8(b) illustrates poor retention of the infused lubricating liquid (53) within the groove, when the group was interrupted by several transverse regions of different wettability (51), spaced apart by L=50 mm, which, even though only slightly in excess of the calculated value of L shows significant drainage in the regions adjacent to the transverse regions of different wettability (51). The “control”, shown on FIG. 8(c) illustrated almost no retention whatsoever of infused lubricating liquid (53) but significant drainage at the bottom region of the test acrylic substrate.

1. A liquid infused surface comprising a pattered surface and a lubricating liquid contained within said patterned surface, wherein when the lubricating liquid is in interfacial contact with a flowing bulk liquid, flow is induced within the lubricating liquid and the lubricating liquid is retained within the patterned surface.

2. A liquid infused surface according to claim 1, wherein the patterned surface comprises one or more surface features which contain the lubricating liquid.

3. Liquid infused surface with reduced drag characteristics, wherein the said liquid infused surface is a patterned surface which include one or more channel type cavities extending inwardly from the surface therefrom which cavities which contain a lubricating liquid, wherein the dimensions of the one or more cavities are such that the lubricating liquid is retained within when in contact with a flowing bulk fluid which imparts a shear force against the lubricating liquid.

4. Liquid infused surface according to claim 3, wherein the one or more cavities have a length dimension, L≦L₄, wherein
$${L}_{∞} = ( \frac{{c}_{p} h}{{c}_{s} {r}_{min}} ) \frac{γ}{{τ}_{yx}}$$
wherein:
h is the height of the cavity,
rₘᵢₙ is the minimum radius of the interface curvature
γ is the surface tension of the interface between the two liquids,
τ_{xy} is the interfacial shear between the two liquids in the direction of flowing liquid,
$${c}_{s} = \frac{1}{2} - \frac{4 h}{w} {\sum }_{n = 0}^{∞} \frac{{( - 1 )}^{n}}{{λ}_{n}^{4}} tanh ( \frac{{λ}_{n} w}{2 h} )$$
$${c}_{p} = \frac{1}{3} - \frac{4 h}{w} {\sum }_{n = 0}^{∞} \frac{1}{{λ}_{n}^{5}} tanh ( \frac{{λ}_{n} w}{2 h} )$$
in each of which:
h is the height of the cavity,
w is the width of the cavity,
λₙ=(n+½)π.

5. Liquid infused surface according to claim 3, wherein L is about 0.05·L₄ to about 0.95·L₄.

6. Liquid infused surface according to claim 3, which includes at least two channel type cavities oriented in a flow-wise direction separated by an intermediate barrier.

7. Liquid infused surface according to claim 6, wherein the intermediate barrier is shorter than the greatest dimension of an adjacent channel type cavity.

8. Liquid infused surface according to claim 6, wherein the intermediate barrier is a surface feature that alters the fluid flow characteristics of the bulk liquid transiting across the infused surface.

9. Liquid infused surface according to claim 6, wherein the intermediate barrier is a physical barrier transverse to the lengthwise direction of the flow of bulk fluid.

10. Liquid infused surface according to claim 6, wherein the barrier is a patterned region of different wettability transverse to the lengthwise direction of flow of the bulk fluid.

11. Liquid infused surface with reduced drag characteristics, wherein the said liquid infused surface is a patterned surfaces having upwardly extending protrusions which extending outwardly from the surface therefrom wherein the surface contains a lubricating liquid between extending protrusions, wherein the dimensions of the one or more protrusions with respect to the area of the surface are such that the lubricating liquid is retained upon the surface when in contact with a flowing bulk fluid which imparts a shear force against the lubricating liquid.

12. A liquid infused surface according to claim 11, further wherein flow is induced within the lubricating liquid and the lubricating liquid is retained within the patterned surface.

13. Liquid infused surface with reduced drag characteristics, wherein the said liquid infused surface is a patterned surfaces having a roughened surface wherein the surface contains a lubricating liquid within the roughened surface, wherein the dimensions of the roughened surface as such that the lubricating liquid is retained upon the surface when in contact with a flowing bulk fluid which imparts a shear force against the lubricating liquid.

14. A liquid infused surface according to claim 13, further wherein flow is induced within the lubricating liquid and the lubricating liquid is retained within the patterned surface.

15. A three-dimensional body comprising a liquid infused surface according to claim 1.

16. A body according to claim 15, which body forms a part of an apparatus or a vehicle.

17. A body according to claim 16, wherein the body is an apparatus selected from: tubes, noncircular flow conduits, open channels, weirs, ducts, fluid-containing vessels, or any other plenum which may be used to contain a flowing liquid.

18. A body according to claim 16, wherein the body is a vehicle selected from: aircraft, a land vehicle, or a water-going vessel.

19. A method of fabricating liquid infused surfaces which feature reduced drag characteristics for a lubricating liquid and a bulk fluid, which method comprises the steps of:
determining suitable dimensions for surface features for the liquid infused surface by,
establishing for a lubricating liquid to be retained within the one or more cavities present below the surface, and for a bulk fluid to be in flowing contact with the surface and with the exposed lubricating liquid, one or both of:
(a) a drag force present at the interface of the exposed surface of lubricating liquid and the flowing bulk fluid; and/or
(b) the maximum satisfactory length, L₄, of the surface features, under steady-state flow conditions of the bulk fluid flowing across the surface.

20. The method according to claim 19, wherein the drag force present at the interface of the exposed surface of lubricating liquid and the flowing bulk fluid is determined from the following equation:
$$DR = a - \frac{a}{{DNb}^{+}} \sqrt{\frac{25}{1 + \frac{5}{{DNb}^{+}}}} arc tanh ( \sqrt{\frac{1}{1 + \frac{5}{{DNb}^{+}}}} )$$
wherein:
DR is the drag reduction,
a is the lubricant area fraction,
b is the cavity width,
D is the depth of the cavity vortex normalized by b,
N is the viscosity ratio between the external fluid and the liquid,
b+≡b/η, with η≡v/uτ and uτ≡, in which:
v is the external fluid viscosity,
uτ is the friction velocity,
τw is the viscous shear stress at the interface between the bulk fluid and the lubricating liquid,
ρ is the external fluid density.

21. The method according to claim 19, wherein the drag force present at the interface of the exposed surface of lubricating liquid and the flowing bulk fluid is determined from the following equation:
$${L}_{∞} = ( \frac{{c}_{p} h}{{c}_{s} {r}_{min}} ) \frac{γ}{{τ}_{yx}}$$
wherein
h is the height of the cavity,
rₘᵢₙ is the minimum radius of the interface curvature
γ is the surface tension of the interface between the two liquids,
τ_{xy} is the interfacial shear between the two liquids in the direction of flowing liquid,
$${c}_{s} = \frac{1}{2} - \frac{4 h}{w} {\sum }_{n = 0}^{∞} \frac{{( - 1 )}^{n}}{{λ}_{n}^{4}} tanh ( \frac{{λ}_{n} w}{2 h} )$$
$${c}_{p} = \frac{1}{3} - \frac{4 h}{w} {\sum }_{n = 0}^{∞} \frac{1}{{λ}_{n}^{5}} tanh ( \frac{{λ}_{n} w}{2 h} )$$
in each of which:
h is the height of the cavity,
w is the width of the cavity,
λₙ=(n+½)π.
